(19) United States
(12) Patent Application Publication
(10) Pub. No.: US 2016/0011421 A1
(43) Pub. Date: Jan. 14, 2016

(54) SELLER GLASSES, CONTROL METHOD THEREOF, COMPUTER READABLE MEDIUM HAVING COMPUTER PROGRAM RECORDED THEREFOR AND SYSTEM FOR PROVIDING CONVENIENCE TO CUSTOMER

(71) Applicant: SK Planet Co., Ltd., Seongnam-si (KR)

(72) Inventors: Tae Yong KIM, Seoul (KR); Hwan Won CHOI, Seoul (KR)

(73) Assignee: SK PLANET CO., LTD., Seongnam-si (KR)

(21) Appl. No.: 14/752,116

(22) Filed: Jun. 26, 2015

(30) Foreign Application Priority Data
Jul. 9, 2014 (KR) 10-2014-0085792
Aug. 19, 2014 (KR) 10-2014-0107985

(51) Int. Cl. G02B 27/01; G06Q 30/00

(52) U.S. Cl. CPC G02B 27/0172; G02B 27/0179; G02B 27/0101; G06Q 30/01; G02B 2027/0178; G02B 2027/0187; G02B 2027/0138; G02B 2027/014; G02B 2027/0143

(57) ABSTRACT

The present invention provides, a pair of seller glasses, a method of controlling the seller glasses, a recording medium having a computer program, and a customer service providing system. That is, the present invention can improve accuracy in detection of customer information by providing an object for accurately detecting customer information by a pair of seller glasses, so it can contribute the improving convenience for a user and providing improved customer services. Further, the present invention can provide customer services based on customer images and can detect changes at every visit of a customer and help a user provide improved customer services on the basis of detected matters, so it can improve convenience of a user.

### CROSS-REFERENCE TO RELATED APPLICATIONS

This application claims the benefit of priority to Korean Application Nos. 10-2014-0085792, filed on Jul. 9, 2014 and 10-2014-0107985, filed on Aug. 19, 2014 with the Korean Intellectual Property Office, the disclosures of which are incorporated herein by reference.

### BACKGROUND OF THE INVENTION

1. Field of the Invention

The present invention relates to seller glasses, a method of controlling the seller glasses, a recording medium having a computer program, and a customer service providing system, and particularly, to seller glasses for accurately acquiring customer information, a method of controlling the seller glasses, a recording medium having a computer program, and a customer service providing system.

2. Description of the Related Art

Wearable displays are devices that are put on close to the eyes of a user to show images, are individually wearable, have a small size, and provide a wide field of view, so they are getting popularized. As wearable displays, there are an HMD (Head Mount Display) and a glasses type display.

Recently, modules of electronic devices are decreased in size with technical development, so they can be mounted on wearable displays, and accordingly, the performance of the wearable displays has been highly improved and varied.

Accordingly, it has been required to search and develop for applying wearable displays to various industries and services.

### PRIOR ART DOCUMENT

### Patent Document

Korean Patent Publication No. 10-2014-0037730 [Title: Wearable system for providing information]

### SUMMARY OF THE INVENTION

An object of the present invention is to provide seller glasses that can improve accuracy in customer information detection by providing an object for accurately detecting customer information, a method of controlling the seller glasses, a recording medium having a computer program, and a customer service providing system.

Further, another object of the present invention is to provide seller glasses that can provide improved customer services to improve convenience for users, a method of controlling the seller glasses, a recording medium having a computer program, and a customer service providing system.

Further, another object of the present invention is to provide seller glasses that can provide customer services based on customer images, a method of controlling the seller glasses, a recording medium having a computer program, and a customer service providing system.

Further, another object of the present invention is to provide seller glasses that can detect changes in every visit of customers and help a user providing improved customer services on the basis of the detected matters, a method of controlling the seller glasses, a recording medium having a computer program, and a customer service providing system.

According to an aspect of the present invention, a pair of seller glasses includes: a head image sensing unit that senses a head image of an object person; a guide information creating unit that acquires guide information that requests a user of the seller glasses at least one of to move or turn his/her head on the basis of the head image; and a display unit that displays the guide information.

According to an embodiment of the present invention, the seller glasses may further include a storage unit that keeps customer data including customer information based on the head image.

According to an embodiment of the present invention, the head image may include directional information.

According to an embodiment of the present invention, the guide information creating unit may acquire guide information on the basis of the directional information.

According to another aspect of the present invention, a method of controlling a pair of seller glasses includes: sensing a head image and directional information of an object person through a head image sensing unit; acquiring guide information that requests a user of the seller glasses at least one of to move or turn his/her head on the basis of the head image and the directional information through a guide information creating unit; and displaying the guide information through a display unit.

According to an embodiment of the present invention, the acquiring of guide information may acquire first guide information that requests movement to the right when the head image includes a left side image of a head, and may acquire second guide information that requests movement to the left when the head image include a right side image of a head.

According to an embodiment of the present invention, the acquiring of guide information may acquire third guide information that requests left turn of a head when the head image includes a left side image of a head, and may acquire fourth guide information that requests right turn of a head when the head image include a right side image of the head.

According to an embodiment of the present invention, when customer information can be acquired on the basis of a head image, a sign object for showing this fact may be displayed.

According to an embodiment of the present invention, the method may further include displaying a sensing region.

According to another aspect of the present invention, a computer program that can perform the method of controlling a pair of seller glasses according to the embodiment may be kept in a recording medium having a computer program.

According to another aspect of the present invention, a customer service providing system may include: a pair of seller glasses that senses a head image and directional information of an object person, acquires guide information that requests a user of the seller glasses at least one of to move or turn his/her head on the basis of the head image and the directional information, and displays the guide information; and a service providing device that receives the head image, acquires customer information on the basis of the head image and customer data, and transmits the customer information to the seller glasses.

According to another aspect of the present invention, pair of seller glasses includes; a customer image taking unit that takes a comparative customer image at a predetermined point of time; a standard customer image acquiring unit that acquires a standard customer image; a customer update information acquiring unit that acquires customer update information on the basis of the standard customer image and the comparative customer image; and a display unit that displays the customer update information.

According to an embodiment of the present invention, the customer update information may exhibit changes in the comparative customer image from the standard customer image.

According to an embodiment of the present invention, the customer update information may include at least one of face information, accessory information, hairstyle information, and clothes information.

According to an embodiment of the present invention, the seller glasses may further include a storage unit that keeps the standard customer image and the comparative customer image.

According to an embodiment of the present invention, the seller glasses may further include a control unit that recognizes customers on the basis of registered images and comparative customer images.

According to an embodiment of the present invention, the control unit may set the comparative customer image as the standard customer image.

According to an embodiment of the present invention, the seller glasses may further include a message acquiring unit that acquires a customer reception message on the basis of the customer update information, in which the display unit may display the customer reception messages.

According to another aspect of the present invention, a method of controlling a pair of seller glasses includes; taking a comparative customer image at a predetermined point of time through a customer image taking unit; acquiring a standard customer image through a standard customer image acquiring unit; acquiring customer update information on the standard customer image and the comparative customer image through a customer update information acquiring unit; and displaying the customer update information through a display unit.

According to an embodiment of the present invention, the method may further include: acquiring a customer reception message on the basis of the customer update information through a message acquiring unit; and displaying the customer reception message through a display unit.

According to an embodiment of the present invention, the method may further include setting the comparative customer image as the standard customer image through a control unit.

According to another aspect of the present invention, a computer program that can perform the method of controlling a pair of seller glasses according to the embodiment may be kept in a recording medium having a computer program.

According to another aspect of the present invention, a customer service providing system includes: a pair of seller glasses that takes a comparative customer image at a predetermined point of time and transmits the comparative customer image; and a service providing device that acquires customer update information and a customer reception message on the basis of a standard customer image therein and the received comparative customer image, and transmits the customer update information and the customer reception message to the seller glasses.

According to the present invention, it is possible to improve accuracy in detection of customer information by providing an object for accurately detecting the customer information.

Further, according to the present invention, it is possible to improve convenience for a user and provide an improved customer service.

Further, according to the present invention, it is possible to provide seller glasses that can provide customer services based on customer images, a method of controlling the seller glasses, a recording medium having a computer program, and a customer service providing system.

Further, according to the present invention, it is possible to provide seller glasses that can detect changes in every visit of customers and help a user providing improved customer services on the basis of the detected matters, a method of controlling the seller glasses, a recording medium having a computer program, and a customer service providing system.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an example when a pair of seller glasses according to an embodiment of the present invention is actually applied to a store.

FIG. 2 is a diagram illustrating in detail use of the seller glasses according to an embodiment of the present invention.

FIG. 3 is a block diagram illustrating the seller glasses according an embodiment of the present invention.

FIG. 4 is a diagram illustrating an example of customer data.

FIGS. 5A and 5B are diagrams illustrating an example of a method of creating guide information.

FIGS. 6A and 6B are diagrams illustrating another example of a method of creating guide information.

FIGS. 7A and 7B are diagrams illustrating another example of a method of creating guide information.

FIGS. 8A and 8B are diagrams illustrating another example of a method of creating guide information.

FIGS. 9A and 9B are diagrams illustrating a difference between the view of a user provided by the seller glasses and an image sensed by a head image sensing unit.

FIGS. 10A and 10b are diagrams illustrating the view of a user provided by the seller glasses and an image sensed by a head image sensing unit.

FIG. 11 is a diagram illustrating an example of a sign object.

FIG. 12 is a block diagram illustrating a pair of seller glasses 100 according an embodiment of the present invention.

FIG. 13 is a diagram illustrating an example of customer data.

FIGS. 14A and 14B are diagrams illustrating examples of a comparative customer image, customer update information, and customer reception message.

FIGS. 15A and 15B are diagrams illustrating other examples of a comparative customer image, customer update information, and customer reception message.

FIGS. 16A and 16B are diagrams illustrating other examples of a comparative customer image, customer update information, and customer reception message.

FIG. 17 is a diagram illustrating an example of changed customer data.

FIG. 18 is a diagram illustrating a customer service providing system according to an embodiment of the present invention.

FIG. 19 is a signal flowchart illustrating a method of controlling a customer service providing system according to an embodiment of the present invention.

### DETAILED DESCRIPTION OF THE EMBODIMENTS

Terminologies used in the specification are used to explain particular embodiments and are not intended to limit the scope of the invention. In addition unless stated specifically otherwise in the specification, the terminologies used in the specification should be construed to have meanings generally understood by those skilled in the art but should not be construed to have unduly exaggerated or reduced meanings. In addition, even if the terminologies used in the specification are incorrect terminologies in expressing the idea of the present invention, these incorrect terminologies should be replaced with correct terminologies so that those skilled in the art can correctly understand the present invention. Moreover, general terms used in the specification should be construed as defined in the dictionary or according to the context and should not be construed to have unduly reduced meanings.

Hereinafter, preferred embodiments of the present invention will be described in detail with reference to the accompanying drawings so that those skilled in the art can easily practice the preferred embodiments. Throughout the drawings, the same or similar elements are denoted by the same reference numerals and explanation of which will not be repeated for the purpose of brevity of description. In the following detailed description of the present invention, concrete description on related functions or constructions will be omitted if it is deemed that the functions and/or constructions may unnecessarily obscure the gist of the present invention. Accordingly, embodiments described in the specification and elements illustrated in the drawings are illustrative only and do not cover all of the technical ideas of the present invention. It should be, therefore, understood that these embodiments and elements may be replaced with different equivalents and modifications at the point of time of filing the present application.

Seller glasses described herein may mean a glasses type electronic device that a person can wear. The seller glasses are a small electronic devices including a central processing unit, a communication unit, a memory, a display, and the like, and capable of processing various data related to services.

An object described herein is an object to which user's intention or action is applied, and for example, may be an image, a moving image, an icon, sound, a data file, and the like. Further, other various types of objects may be considered.

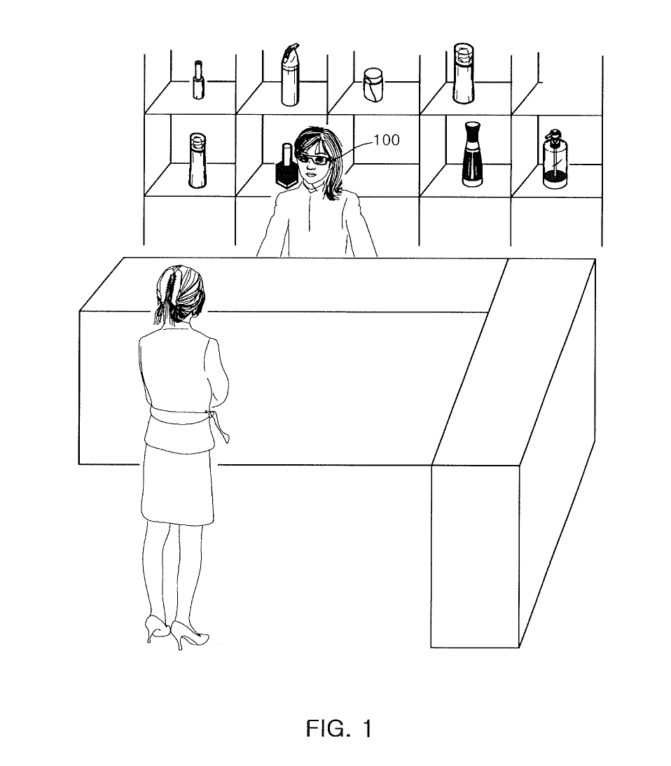

FIG. 1 is a diagram illustrating an example when a pair of seller glasses according to an embodiment of the present invention is actually applied to a store.

As illustrated in FIG. 1, people in a service industry can wear a pair of seller glasses 100 and provide customer service on the basis of various data displayed on the seller glasses 100.

That is, according to an embodiment of the present invention, the seller glasses 100 can sense a head image of a customer, acquire customer information on the basis of the sensed head image, and display the customer information so that a clerk can check the customer information. Accordingly, a clerk can provide improved customer service, using various customer information displayed on the seller glasses 100.

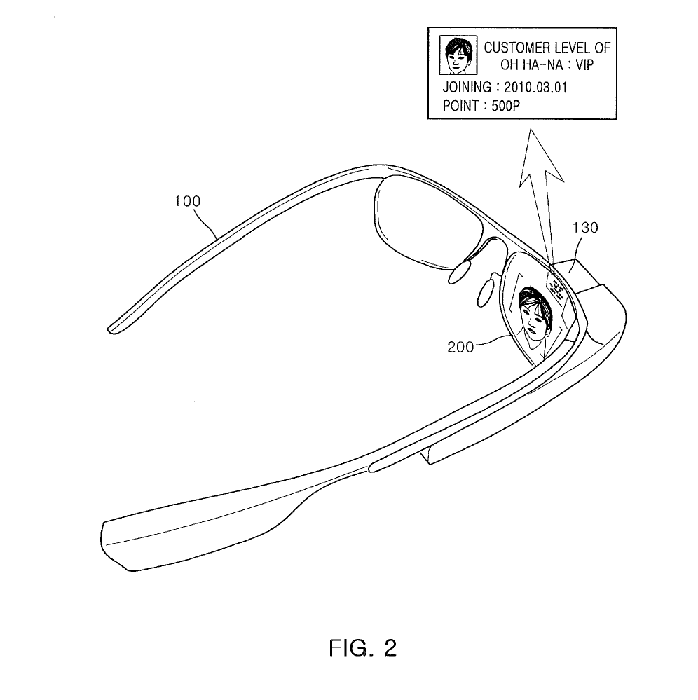

FIG. 2 is a diagram illustrating in detail use of the seller glasses according to an embodiment of the present invention.

As illustrated in FIG. 2, the seller glasses 100 may include a display unit 130. A clerk wearing the seller glasses 100 can recognize a customer through lens units 200 of the seller glasses 100. Further, the display unit 130 of the seller glasses 100 can display customer information acquired by a head image sensing unit.

According to an embodiment of the present invention, the display unit 130 can display customer information such as a customer name, the membership level of a customer, a membership joining date, and a membership point.

A clerk wearing the seller glasses 100 can recognize information about a customer through customer information such as a customer name, the membership level of a customer, a membership joining date, and a membership point displayed on the display unit 130 of the seller glasses 100 and can provide a customized service for each customer.

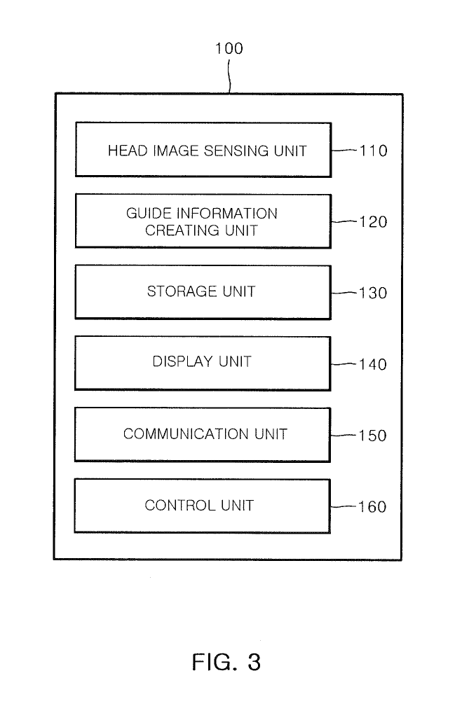

FIG. 3 is a block diagram illustrating the seller glasses 100 according an embodiment of the present invention.

As illustrated in FIG. 3, the seller glasses 100 may include a head image sensing unit 110, a guide information creating unit 120, a display unit 130, a storage unit 140, a communication unit 150, and a control unit 160. The components of the seller glasses 100 illustrated in FIG. 3 are not all necessary components, and the seller glasses 100 may be composed of components more or less than the components illustrated in FIG. 3.

The storage unit 140 can keep customer data including customer information based on head images.

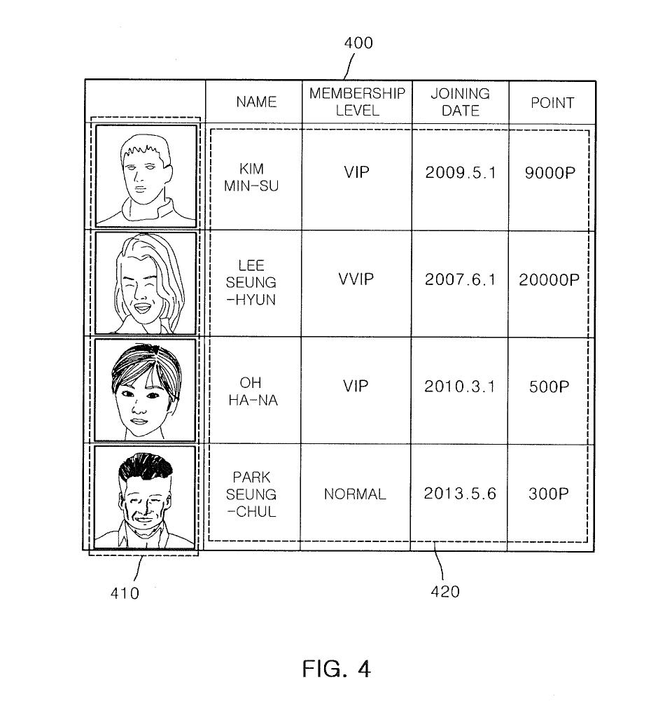

FIG. 4 is a diagram illustrating an example of customer data.

As illustrated in FIG. 4, the customer data 400 can include customer information 420 based on head images 410.

Herein, the head images 410 may be the front images of customers' heads. The head images 410 may be left or right images of customers' heads. Any one of a front image, a left image, and a right image of the customer's head may be set as a standard image.

The head image sensing unit 110 can sense a head image of an object person. Preferably, the object person may be a person who can be recognized by a clerk wearing the seller glasses 100 through the lens unit 200 of the seller glasses 100.

That is, the head image sensing unit 110 can sense the head of a person who a user can recognize through the lens unit 200.

Further, the head image sensing unit 110 can sense directional information. That is, the head image sensing unit 110 can find out whether a sensed head image is the front, right, or left image of the head.

Further, the directional information acquired by the head image sensing unit 110 can include information about how much the head has turned left or right from the front image of the head.

The communication unit 150 may transmit/receive data to/from a service providing device. For example, when customer data kept in the storage unit exist in the service providing device, the communication unit 150 can transmit a head image to the service providing device and receive customer information from the service providing device.

The control unit 160 is functionally connected with the head image sensing unit 110, the guide information creating unit 120, the display unit 130, the storage unit 140, and the communication unit 150 and can control the entire operation of the seller glasses.

The guide information creating unit 120 can acquire guide information on the basis of a head image. Herein, the guide information may be an object exhibiting movement of a user, and the turning degree of the user's head for the seller glasses 100 to detect a standard image of a head (for example, the front image of a head).

That is, the guide information creating unit 120 can acquire guide information for requesting at least one of movement of a user of the seller glasses and turning of the head of the user of the seller glasses on the basis of a head image.

Further, the guide information creating unit 120 can acquire guide information on the basis of directional information acquired by the head image sensing unit 110.

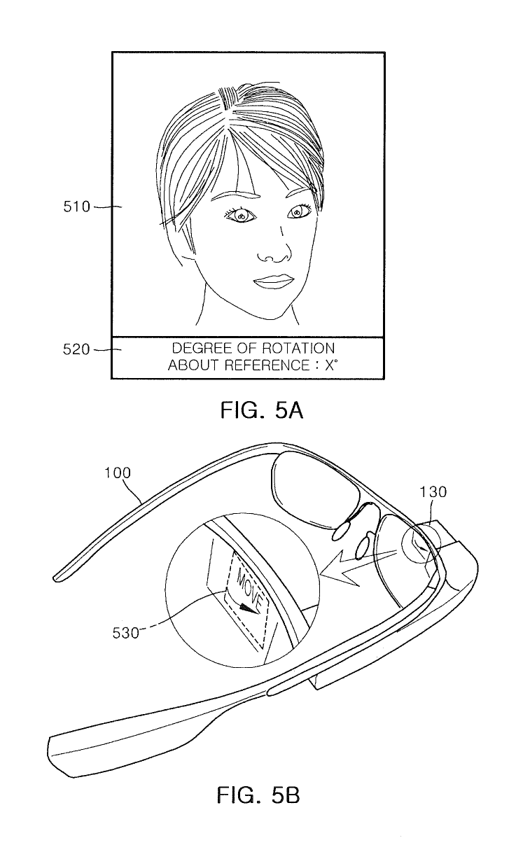

FIGS. 5A and 5B are diagrams illustrating an example of a method of creating guide information.

FIG. 5A illustrates an example of a head image 510 and directional information 520 sensed by the head image sensing unit 110. FIG. 5B illustrates an example of guide information according to a head image and directional information.

Meanwhile, when a head image includes a left image 510 of a head, the guide information creating unit 120 can acquire first guide information 530 that requests the user to move right.

In this case, the display unit 130 can display the first guide information 530.

For example, when a standard image is set as a front image of a head and a clerk looks at a customer at the left side of the customer, the head image sensing unit 110 cannot accurately sense the front image of the customer.

According to an embodiment of the present invention, when it is required to sense the front image of a customer, the seller glasses 100 can request the user to move by displaying the first guide information that requests the user to move right.

When the user wearing the seller glasses 100 recognizes the first guide information and moves to a position where the seller glasses 100 can sense the front image of the customer, the seller glasses 100 can acquire the front image that is the standard image and accurately acquire and display customer information.

Although the standard image is set as the front image of a head in this specification for the convenience of description, it is apparent to those skilled in the art that the present invention can stilled be applied even if the standard image is set in other ways.

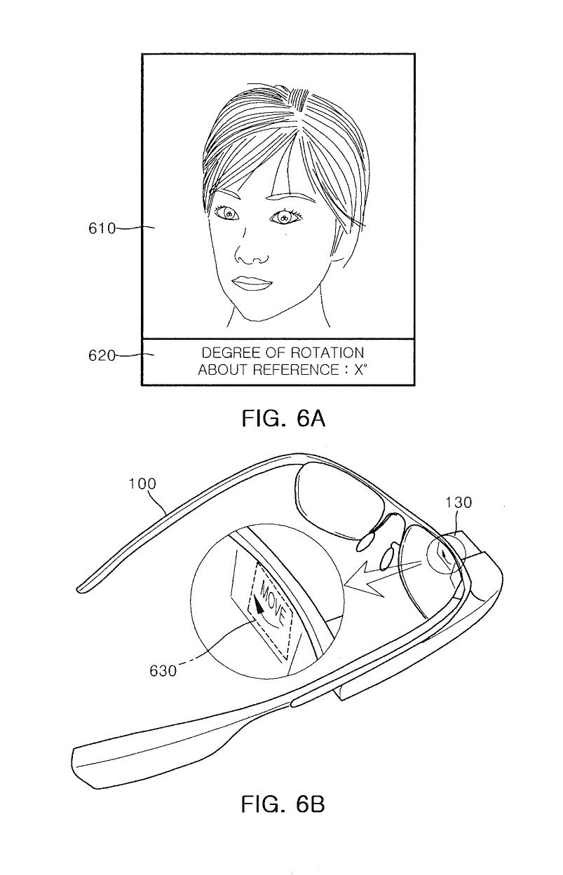

FIGS. 6A and 6B are diagrams illustrating another example of a method of creating guide information.

FIG. 6A illustrates an example of a head image 610 and directional information 620 sensed by the head image sensing unit 110. FIG. 6B illustrates an example of guide information according to a head image and directional information.

Meanwhile, when a head image includes a right image 610 of a head, the guide information creating unit 120 can acquire second guide information 630 that requests the user to move left.

In this case, the display unit 130 can display the second guide information 630.

For example, when a standard image is set as a front image of a head and a clerk looks at a customer at the right side of the customer, the head image sensing unit 110 cannot accurately sense the front image of the customer.

According to an embodiment of the present invention, when it is required to sense the front image of a customer, the seller glasses 100 can request the user to move by displaying the second guide information that requests the user to move left.

When the user wearing the seller glasses 100 recognizes the second guide information and moves to a position where the seller glasses 100 can sense the front image of the customer, the seller glasses 100 can acquire the front image that is the standard image and accurately acquire and display customer information.

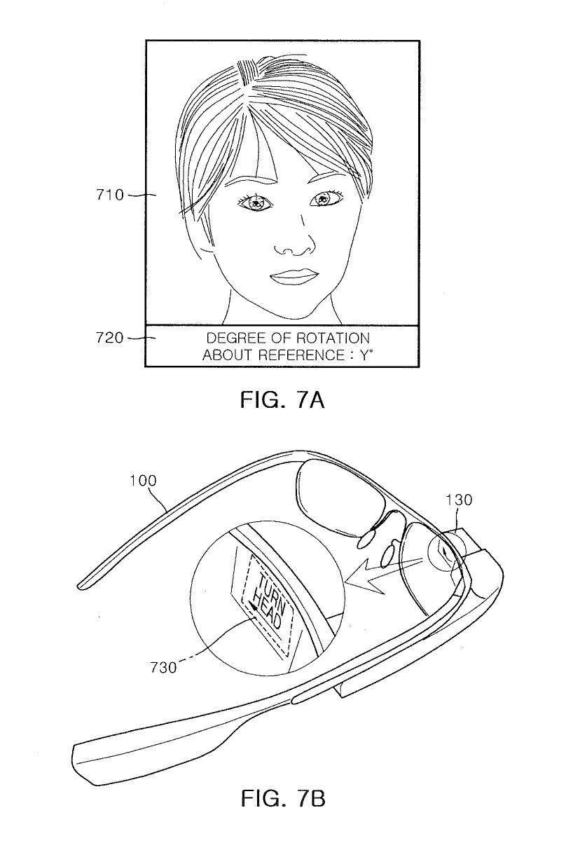

FIGS. 7A and 7B are diagrams illustrating another example of a method of creating guide information.

FIG. 7A illustrates an example of a head image 710 and directional information 720 sensed by the head image sensing unit 110. FIG. 7B illustrates an example of guide information according to a head image and directional information.

Meanwhile, when a head image 710 includes a left image of a head more than a right image of the head, the guide information creating unit 120 can acquire third guide information 730 that requests the user to turn his/her head to the left.

In this case, the display unit 130 can display the third guide information 730.

According to an embodiment of the present invention, when it is required to sense the front image of a customer, the seller glasses 100 can request the user to turn his/her head by displaying the third guide information that requests the user to turn his/her head to the left.

According to an embodiment of the present invention, a front head image of a customer can be accurately detected.

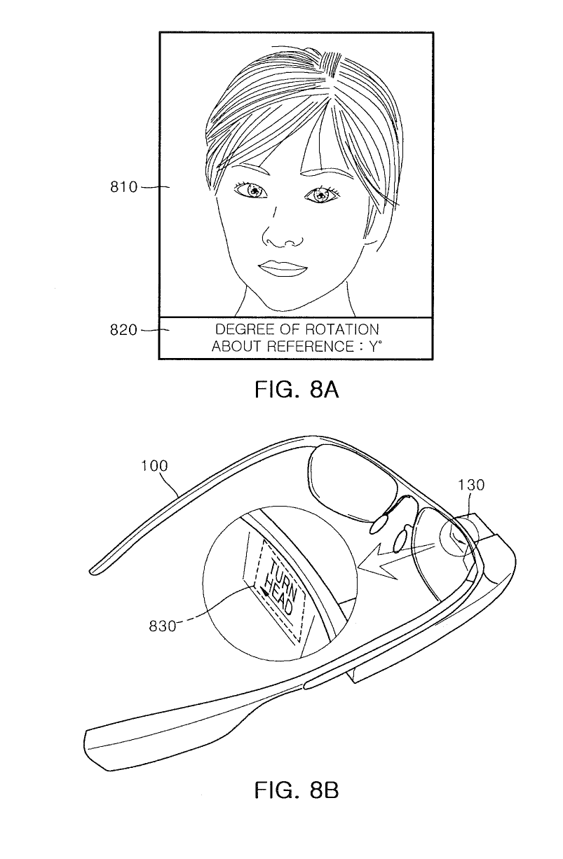

FIGS. 8A and 8B are diagrams illustrating another example of a method of creating guide information.

FIG. 8A illustrates an example of a head image 810 and directional information 820 sensed by the head image sensing unit 110. FIG. 8B illustrates an example of guide information according to a head image and directional information.

Meanwhile, when a head image 710 includes a right image of a head more than a left image of the head, the guide information creating unit 120 can acquire fourth guide information 830 that requests the user to turn his/her neck to the right.

In this case, the display unit 130 can display the fourth guide information 830.

According to an embodiment of the present invention, when it is required to sense the front image of a customer, the seller glasses 100 can request the user to turn his/her head by displaying the fourth guide information that requests the user to turn his/her head to the right.

According to an embodiment of the present invention, a front head image of a customer can be accurately detected.

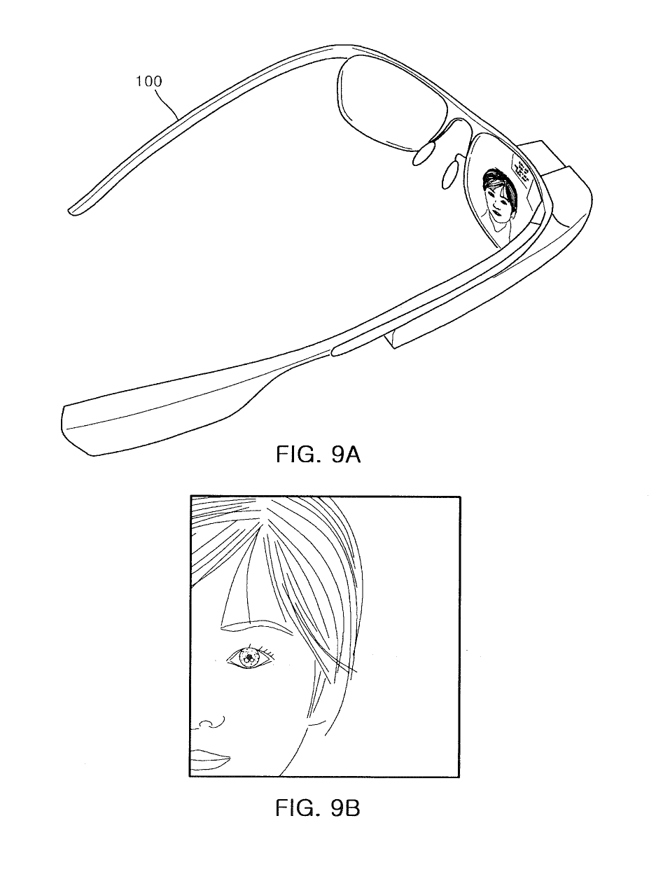

FIGS. 9A and 9B are diagrams illustrating a difference between the view of a user provided by seller glasses and an image sensed by a head image sensing unit.

FIG. 9A is a diagram illustrating the view of a user through the seller glasses. FIG. 9B is a diagram illustrating an image sensed by the head image sensing unit.

As illustrated in FIGS. 9A and 9B, an image that a person wearing the seller glasses looks at and an image sensed by the seller glasses may be different. That is, even if a person wearing the seller glasses thinks that he/she is looking at a customer, the customer may be out of the sensing range of the seller glasses.

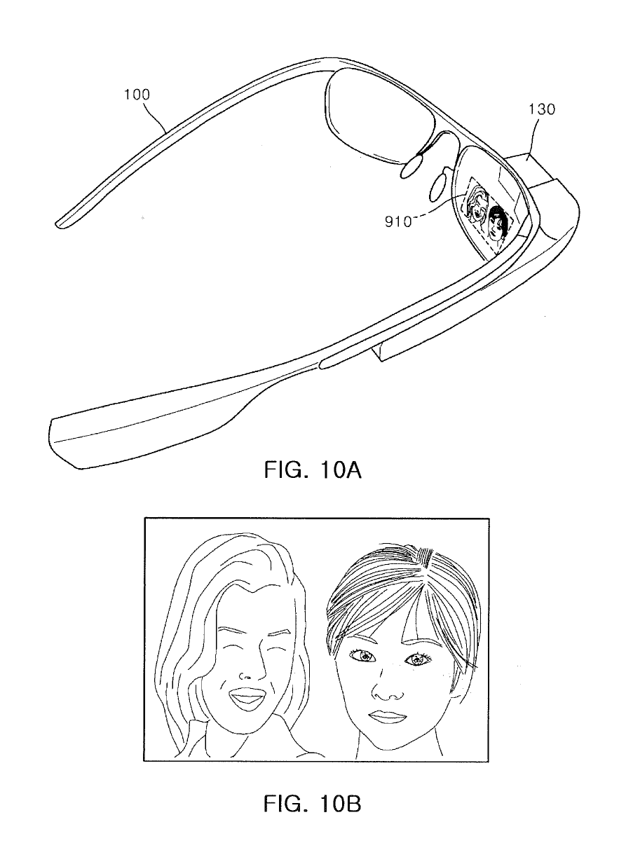

FIGS. 10A and 10B are diagrams illustrating the view of a user provided by seller glasses and an image sensed by a head image sensing unit.

Referring to FIG. 10A, the seller glasses can display a sensing range that is the area that the head image sensing unit of the seller glasses can sense, in the view through the lenses of the seller glasses.

The sensing range 910 of the seller glasses can accurately display the area (FIG. 10B) that the head image sensing unit can sense, so the user can use this range to accurately acquire a head image of a customer.

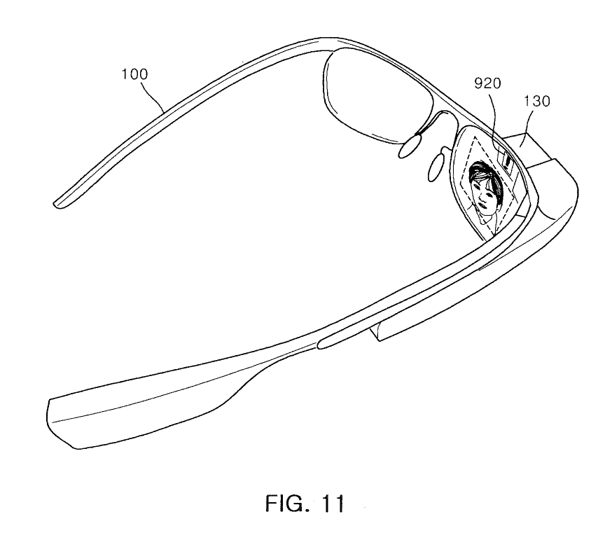

FIG. 11 is a diagram illustrating an example of a sign object.

According to an embodiment of the present invention, when it is possible to acquire customer information on the basis of a head image, the display can display a sign object 920 for showing that.

As described above, the seller glasses according to an embodiment of the present invention can improve accuracy in detection of customer information by providing an object for accurately detecting customer information, so it can contribute the improving convenience for a user and providing improved customer services.

A method of controlling a pair of seller glasses according to an embodiment of the present invention can be recorded in a computer program, and codes and code segments of the computer program can be easily inferred by computer programmers in the field. Further, the computer program is stored in computer readable media, and read and executed by a computer or a user device according to an embodiment of the present invention, so a method of controlling the user device can be implemented.

An information recording medium includes a magnetic recording medium, an optical recording medium, and a carrier wave medium. A computer program for achieving the method of controlling a pair of seller glasses according to an embodiment of the present invention may be stored and installed in a built-in memory in the seller glasses. Alternatively, an external memory such as a smart card in which a computer program for achieving the method of controlling a pair of seller glasses according to an embodiment of the present invention is stored and installed may be mounted on the seller glasses through an interface.

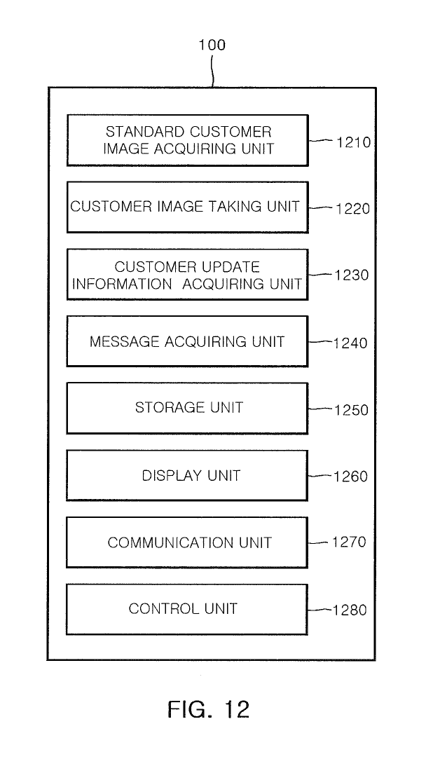

FIG. 12 is a block diagram illustrating a pair of seller glasses 100 according another embodiment of the present invention.

As illustrated in FIG. 12, the seller glasses 100 may include a standard customer image acquiring unit 1210, a customer image taking unit 1220, a customer update information acquiring unit 1230, a message acquiring unit 1240, a storage unit 1250, a display unit 1260, a communication unit 1270, and a control unit 1280. The components of the seller glasses 100 illustrated in FIG. 12 are not all necessary components, and the seller glasses 100 may be composed of components more or less than the components illustrated in FIG. 12.

The storage unit 1250 can keep customer data including customer information based on registered images.

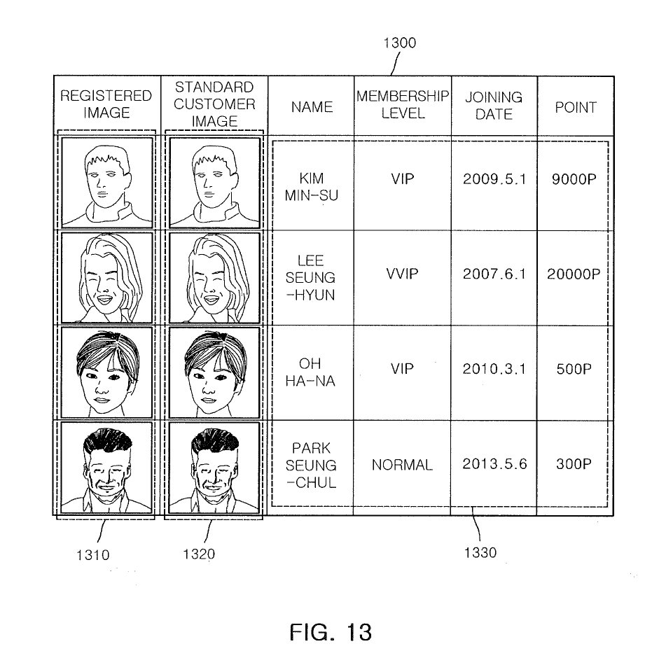

FIG. 13 is a diagram illustrating an example of customer data.

As illustrated in FIG. 13, the customer data 1300 can include standard customer images 1320 and customer information 1330 based on registered images 1310.

Herein, the registered images 1310 may be images of each customer, when customer data are registered. The registered images 1310 may be the front images of customers' heads. The head images 1310 may be left or right side images of customers' heads. Any one of a front image, a left image, and a right image of the customer's head may be set as a standard image.

The registered images may be comparative images used for recognizing customers.

That is, the control unit 1280 can recognize customers on the basis of customer image taken by the customer image taking unit 1220 and the registered images.

The standard customer images may be comparative images used to acquire customer update information.

That is, the customer update information acquiring unit 1230 can acquire customer update information on the basis of the customer images taken by the customer image taking unit 1220 and the standard customer images.

In detail, the standard customer image acquiring unit 1210 can acquire standard customer images. Herein, the standard customer images may be images of customers taken at a first point of time. Herein, the image of customers may include face information, accessory information, hairstyle information, clothes information, and the like.

The standard customer image acquiring unit 1210 can acquire standard customer images from the storage unit 1250 or the service providing device.

The customer image taking unit 1220 can take comparative customer images. Herein, the comparative customer images may be images of customers taken at a second point of time. Herein, the second point of time is later than the first point of time.

The customer update information acquiring unit 1230 can acquire changes in comparative customer images from the standard customer images on the basis of the standard customer images acquired by the standard customer image acquiring unit and the comparative customer image acquired by the customer image taking unit. Herein, the changes in the comparative customer images from the standard customer images may be referred to as customer update information.

Herein, the customer update information may include face information, accessory information, hairstyle information, clothes information, and the like.

The message acquiring unit 1240 can acquire customer reception messages on the basis of the customer update information. Herein, the customer reception messages may be information for helping a clerk receive customers on the basis of the customer update information.

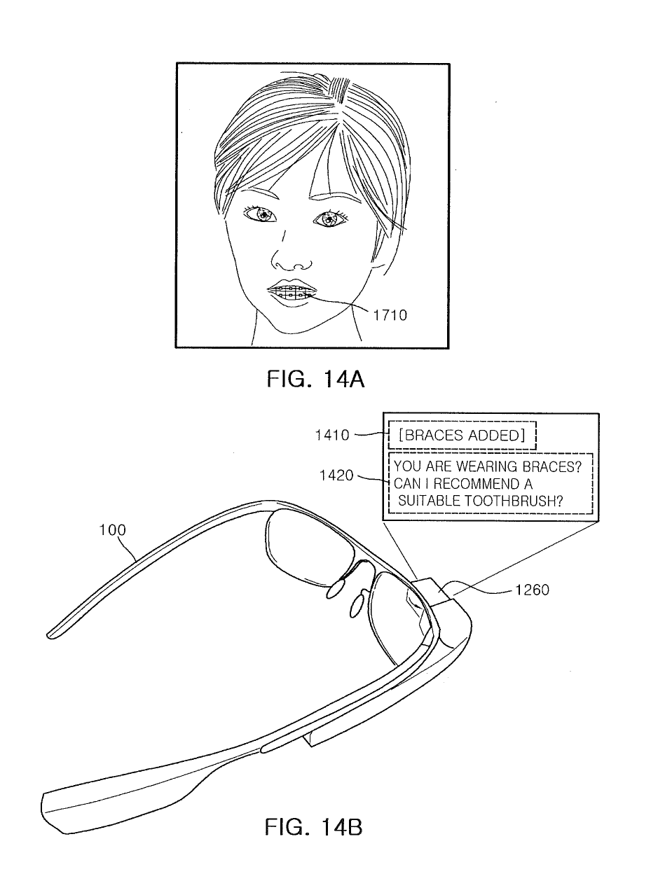

FIGS. 14A and 14B are diagrams illustrating examples of a comparative customer image, customer update information, and customer reception message.

FIG. 14A illustrating a comparative customer image of a customer (for example, OH Ha-Na) acquired by the seller glasses.

Herein, it is assumed that the customer data 1300 illustrated in FIG. 13 is provided.

Referring to FIGS. 13 to 14B, comparing a standard customer image with a comparative customer image of a customer ‘OH Ha-Na’, it can be seen that braces 1710 was added to the comparative customer image.

In this case, the customer update information acquiring unit 1230 can acquire the added braces 1710 as customer update information.

Meanwhile, the message acquiring unit 1240 can acquire a customer reception message about the added braces 1710. For example, when the seller glasses are used in a pharmacy, the seller glasses may acquire product information related to braces of products in the pharmacy and show them to the user.

FIG. 14B illustrates an example of customer update information 1410 and a customer reception message 1420 displayed by the display unit 1260.

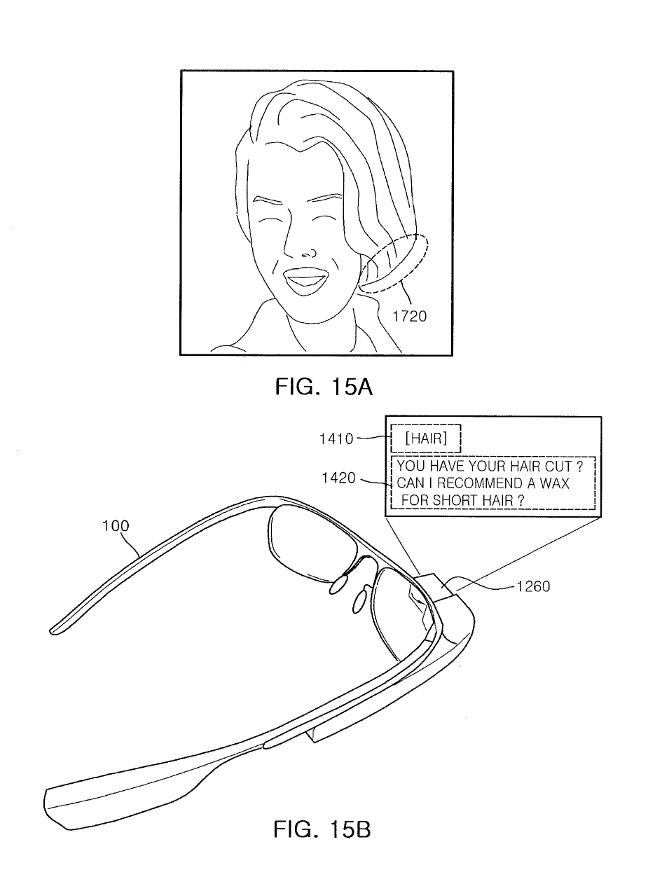

FIGS. 15A and 15B are diagrams illustrating other examples of a comparative customer image, customer update information, and customer reception message.

FIG. 15A illustrating a comparative customer image of a customer (for example, LEE Seung-Hyun) acquired by the seller glasses.

Herein, it is assumed that the customer data 1300 illustrated in FIG. 13 is provided.

Referring to FIGS. 13 to 15B, comparing a standard customer image with a comparative customer image of a customer ‘LEE Seung-Hyun’, it can be seen that the hair of the customer is shorter in the comparative customer image.

In this case, the customer update information acquiring unit 1230 can acquire hairstyle information 1720 as customer update information.

Meanwhile, the message acquiring unit 1240 can acquire a customer reception message about the changed hairstyle information 1720. For example, when the seller glasses are used in a cosmetic store, the seller glasses may acquire product information related to hair of products in the cosmetic store and show them to the user.

FIG. 15B illustrates an example of customer update information 1410 and a customer reception message 1420 displayed by the display unit 1260.

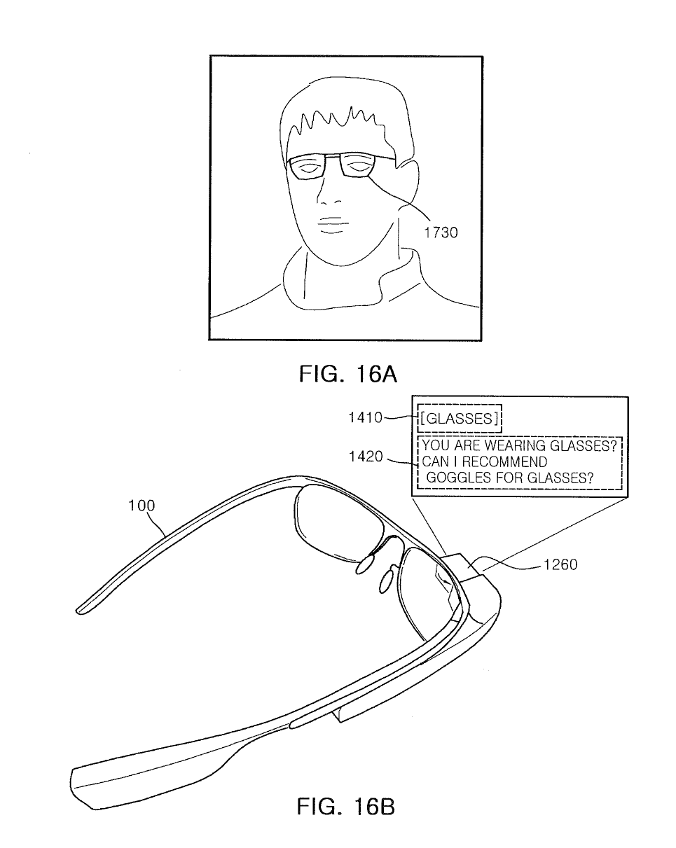

FIGS. 16A and 16B are diagrams illustrating other examples of a comparative customer image, customer update information, and customer reception message.

FIG. 16A illustrating a comparative customer image of a customer (for example, KIM Min-Su) acquired by the seller glasses.

Herein, it is assumed that the customer data 1300 illustrated in FIG. 13 is provided.

Referring to FIGS. 13 to 16B, comparing a standard customer image with a comparative customer image of a customer ‘KIM Min-Su’, it can be seen that a pair of glasses 1730 was added to the comparative customer image.

In this case, the customer update information acquiring unit 1230 can acquire the added glasses 1730 as customer update information.

Meanwhile, the message acquiring unit 1240 can acquire a customer reception message about the added glasses 1730. For example, when the seller glasses are used in a ski shop, the seller glasses may acquire product information related to glasses of products in the ski shop and show them to the user.

FIG. 16B illustrates an example of customer update information 1410 and a customer reception message 1420 displayed by the display unit 1260.

Meanwhile, the storage unit 1250 can store a standard customer image and a comparative customer image.

As described above, the display unit 1260 can display the customer update information and the customer reception message.

Meanwhile, the control unit 1280 can set the comparative customer image as a standard customer image.

According to an embodiment of the present invention, since it is required to check changes of a customer at the next visit from the last visit, it is required to set a comparative customer image as a standard customer image.

Therefore, according to an embodiment of the present invention, the storage unit 1250 can keep the image of customer at the last visit as the standard customer image.

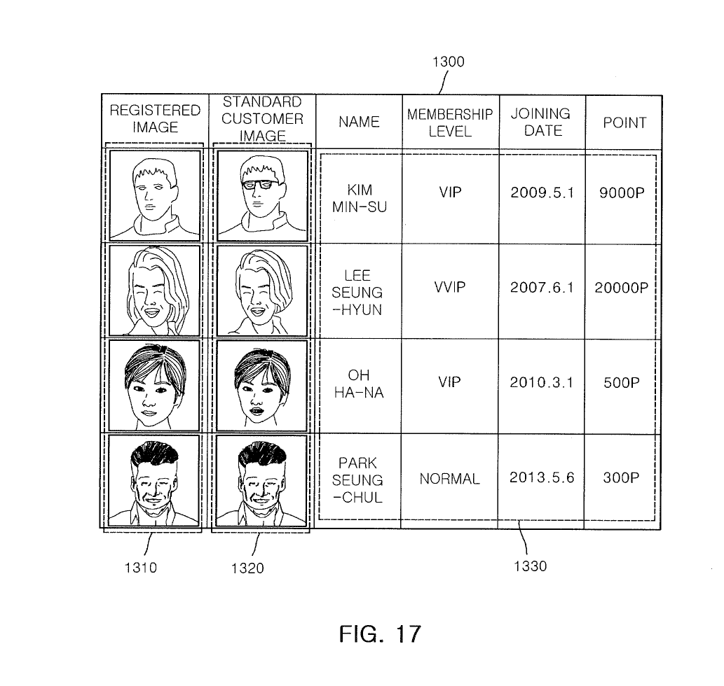

FIG. 17 is a diagram illustrating an example of changed customer data.

When the storage unit 1250 keeps the customer data illustrated in FIG. 13 and the comparative customer images illustrated in FIGS. 14A, 6A, and 7A are acquired, the acquired comparative customer images may be set as standard customer images, as illustrated in FIG. 17.

The communication unit 1270 may transmit/receive data to/from a service providing device. For example, when customer data are in the service providing device, the communication unit 1250 can transmit comparative customer images to the service providing device and receive customer update information and customer reception messages from the service providing device.

That is, the configuration of the seller glasses illustrated in FIG. 12 may be divided to the service providing device 200. Herein, the seller glasses 100 and the service providing device 200 can transmit/receive necessary data communication by the communication unit 1270.

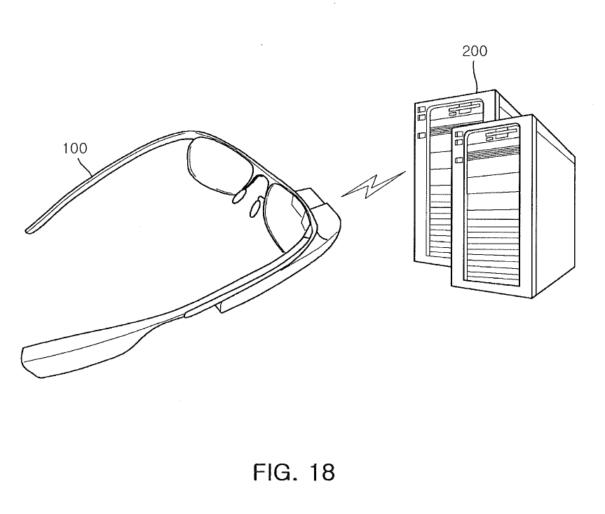

FIG. 18 is a diagram illustrating a customer service providing system according to an embodiment of the present invention.

As illustrated in FIG. 18, the customer service providing system may include the seller glasses 100 and the service providing device 200.

The service providing device 200 may have a configuration that receives comparative customer images taken by the seller glasses 100 and acquires customer update information and customer reception messages on the basis of the comparative customer images. The service providing device 200 can transmit the acquired customer update information and the customer reception messages to the seller glasses 100.

Accordingly, a user wearing the seller glasses 100 can check changes every time customers visit and can be helped to provide a customer service based on the detected matters.

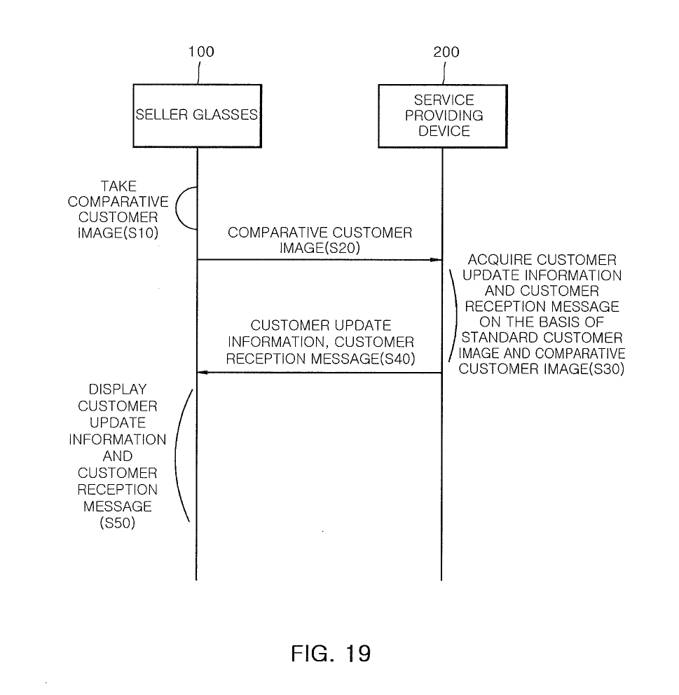

FIG. 19 is a signal flowchart illustrating a method of controlling a customer service providing system according to an embodiment of the present invention.

According to an embodiment of the present invention, the seller glasses 100 can take comparative customer images (S10). Further, the seller glasses can transmit the taken comparative customer images to the service providing device 200.

The service providing device 200 may have standard customer images. Accordingly, the service providing device 200 can acquire customer update information and customer reception messages on the basis of the standard customer images and the comparative customer images (S30).

Further, the service providing device 200 can transmit the acquired customer update information and the customer reception messages to the seller glasses 100 (S40).

Meanwhile, the seller glasses 100 can display the received customer update information and the customer reception messages.

Accordingly, the seller glasses according to an embodiment of the present invention can contribute to providing a customer service based on a customer image and can contribute to detecting changes at every visit of a customer and providing an improved customer service on the basis of the detected matters.

A method of controlling a pair of seller glasses according to an embodiment of the present invention can be recorded in a computer program, and codes and code segments of the computer program can be easily inferred by computer programmers in the field. Further, the computer program is stored in computer readable media, and read and executed by a computer or a user device according to an embodiment of the present invention, so a method of controlling the user device can be implemented.

An information recording medium includes a magnetic recording medium, an optical recording medium, and a carrier wave medium. A computer program for achieving the method of controlling a pair of seller glasses according to an embodiment of the present invention may be stored and installed in a built-in memory in the seller glasses. Alternatively, an external memory such as a smart card in which a computer program for achieving the method of controlling a pair of seller glasses according to an embodiment of the present invention is stored and installed may be mounted on the seller glasses through an interface.

It should be understood that the present invention may be changed and modified by those skilled in the art without departing from the scope of the present invention. Accordingly, the embodiment described herein are provided not to limit, but to explain the spirit of the present invention and the spirit and the scope of the present invention are not limited by the embodiments. The protective range of the present invention should be construed on the basis of claims and all the technical spirits in the equivalent range should be construed as being included in the scope of the right of the present invention.

The present invention can improve accuracy in detection of customer information by a pair of seller glasses by providing objects for accurately detecting the customer information, can improve convenience for a user, and can contribute to providing an improved customer service, so the present invention can be used in various fields such as marketing and a commercial transaction.

What is claimed is:

1. A pair of seller glasses comprising:
a head image sensing unit that senses a head image of an object person;
a guide information creating unit that acquires guide information that requests a user of the seller glasses at least one of to move or turn his/her head on the basis of the head image; and
a display unit that displays the guide information.

2. The seller glasses of claim 1, further comprising a storage unit that keeps customer data including customer information based on the head image.

3. The seller glasses of claim 1, wherein the head image includes directional information.

4. The seller glass of claim 3, wherein the guide information creating unit acquires guide information on the basis of the directional information.

5. A method of controlling a pair of seller glasses, comprising:
sensing a head image and directional information of an object person through a head image sensing unit;
acquiring guide information that requests a user of the seller glasses at least one of to move or turn his/her head on the basis of the head image and the directional information through a guide information creating unit; and
displaying the guide information through a display unit.

6. The method of claim 5, wherein the acquiring of guide information acquires first guide information that requests movement to the right when the head image includes a left side image of a head, and acquires second guide information that requests movement to the left when the head image include a right side image of a head.

7. The method of claim 5, wherein the acquiring of guide information acquires third guide information that requests left turn of a head when the head image includes a left side image of a head, and acquires fourth guide information that requests right turn of a head when the head image include a right side image of the head.

8. The method of claim 5, wherein when customer information can be acquired on the basis of a head image, a sign object for showing this fact is displayed.

9. The method of claim 5, further comprising displaying a sensing region.

10. A recording medium having a computer program that performs the method of claim 5.

11. A pair of seller glasses comprising;
a customer image taking unit that takes a comparative customer image at a predetermined point of time;
a standard customer image acquiring unit that acquires a standard customer image;
a customer update information acquiring unit that acquires customer update information on the basis of the standard customer image and the comparative customer image; and
a display unit that displays the customer update information.

12. The seller glasses of claim 11, wherein the customer update information exhibits changes in the comparative customer image from the standard customer image.

13. The seller glasses of claim 12, wherein the customer update information includes at least one of face information, accessory information, hairstyle information, and clothes information.

14. The seller glasses of claim 11, further comprising a storage unit that keeps the standard customer image and the comparative customer image.

15. The seller glasses of claim 14, further comprising a control unit that recognizes customers on the basis of registered images and comparative customer images.

16. The seller glasses of claim 15, wherein the control unit sets the comparative customer image as the standard customer image.

17. The seller glasses of claim 11, further comprising a message acquiring unit that acquires a customer reception message on the basis of the customer update information,
wherein the display unit displays the customer reception messages.
